(19) United States
(12) Patent Application Publication
(10) Pub. No.: US 2004/0246093 A1
(43) Pub. Date: Dec. 9, 2004

(54) Heating element with areal resistor

(76) Inventor: Michael Weiss, Benediktbeuren (DE)

Correspondence Address: ARTZ & ARTZ, P.C., 28333 TELEGRAPH RD., SUITE 250, SOUTHFIELD, MI, 48034, US

(21) Appl. No.: 10/484,532

(22) PCT Filed: Aug. 28, 2002
(86) PCT No.: PCT/DE02/03184

(30) Foreign Application Priority Data
Sep. 3, 2001 (DE) 10142877.4

(51) Int. Cl. H01C 1/08

(52) U.S. Cl. 338/59

(57) ABSTRACT

A heating element (1) having an areal heating resistor (2) and two elongated contact areas (4, 4′), arranged at a distance from each other on the heating resistor (2) with the area (6, 6′) of the heating resistor (2) to be heated essentially between them. The heating element (1) includes at least one standard area (8, 8′) and at least one special area (10) in which the distances (12, 13) of the contact areas (4, 4′) from each other are different The heating element (1) includes at least one barrier area (16, 16′) electrically insulating the standard area (8, 8′) and the special area (10) from each other, and in the special area (10), the electrical conductivity of the heating resistor (2) is different from that of the standard area (8, 8′).

The present invention relates to a heating element according to the generic clause of claim 1. Heating elements of this kind are used for example to heat steering wheels in motor vehicles.

### PRIOR ART

Heating of surfaces of articles of use that come into contact with persons is known. For that purpose, an areal heating resistor is applied to the surface to be heated and then electrically heated.

These systems have been successful for geometrically simple surfaces.

For three-dimensional surfaces of more complicated shape, however, the arrangement of such heating elements is difficult. A typical example in a steering wheel are the junctions of the spokes with the rim.

### OBJECT OF THE INVENTION

The heating element according to claim 1 has the advantage that even geometrically complicated surfaces can be electrically contacted and heated in simple manner.

A heating element according to claim 2 has the advantage that it can be adapted to curved as well as flat surfaces without folding.

A heating element according to claim 3 is simple to manufacture.

A heating element according to claim 4 is economical and will support heavy mechanical loads.

A means according to claim 5 makes it possible to heat the junctions of the rim with the spokes of a steering wheel as well. This is important because many drivers will rest their thumbs on the spokes.

### FIGURES

The description to follow deals with possible embodiments of the invention. These embodiments are to be taken by way of example only, and with reference to:

FIG. 1 Top view of a portion of a heating element according to the invention

FIG. 2 Schematic top view of a steering wheel

### DESCRIPTION OF THE INVENTION

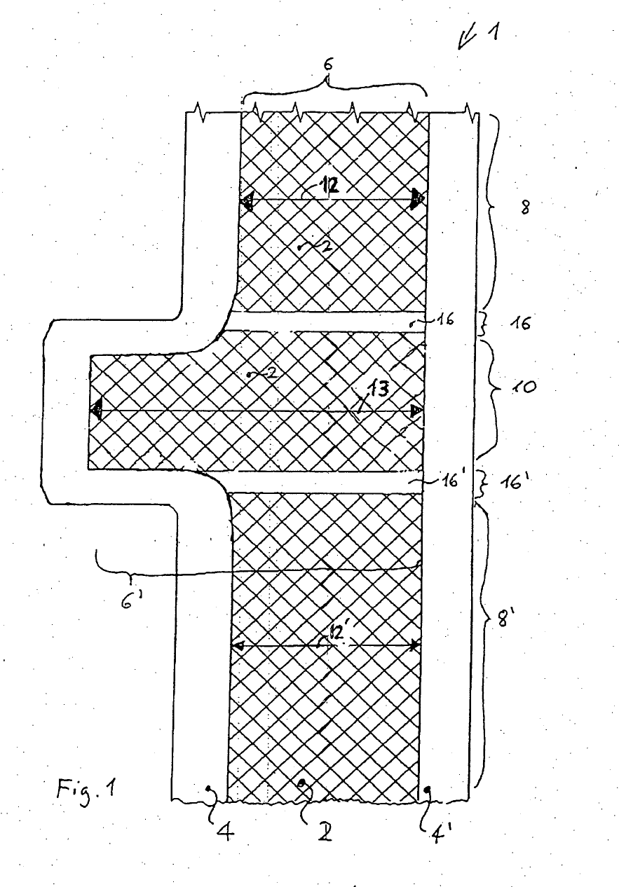

FIG. 1 shows a portion of a heating element 1. The heating element 1 has an elongated heating resistor 2. Along the heating resistor 2, a first and a second contact area (4, 4′) are arranged. These contact areas (4, 4′) are electrically conductively connected to the heating resistor 2 throughout their length.

The portion of the heating element 1 as shown in FIG. 1 has three areas in a first and a second standard area (8, 8′), the heating resistor 2 has a more or less constant breadth. The distances 12, 12‘of the first and’ the second contact areas (4, 4′) from each other are therefore likewise about equal.

Between the first and the second standard area (8, 8′), a special area 10 is arranged. In this special area 10, the breadth of the heating resistor 2 is not the same as in the standard area (8, 8′). Therefore the distance 13 of the contact areas (4, 4′) from the standard area (8, 8′) is also different from the distance 12, 12′. In the present case, it is greater.

The heating resistor 2 comprises filaments and/or fibers that are electrically conductive or conductively coated. These filaments/fibers establish an electrically conductive connection between the first and second contact areas (4, 4′).

The density of the filaments/fibers, viz. their number per unit volume or area, leads to a certain conductivity of a heating resistance in the standard areas (8, 8′). In cooperation with the distance 12, 12′ of the two contact areas (4, 4′) from each other, this leads to a certain, resistance of the heating resistor 2 in the standard area (8, 8′).

The filaments/fibers may be arranged undirected, e.g. in the form of a fleece. In the present example, however, they are stitched (not shown) to a textile support. Thus, they run more or less at right angles to the direction of extent of the contact areas (4, 4′), from one contact area (4) to the other contact area (4′). The mean distance of the filaments/fibers from each other determines the number of filaments per unit area, and hence the conductivity of the heating resistor 2 in the standard area 8, 8′.

In the special area 10, electrically conductive or conductively coated filaments/fibers are likewise provided. Their density, however, is different from the density in the standard area (8, 8′). In the present case, their density is enhanced. As a result, the electrical conductivity of the heating resistor 2 in the special area 10 is altered—here, that is, lessened. The density of the conductive filaments/fibers is preferably so chosen that the total electrical resistance of the heating resistor 2 in the standard areas (8, 8′) and in the special area 10 will be identical. An enhanced resistance due to an increased distance between the two contact areas (4, 4′) will thus be offset by an enhanced electrical conductivity due to a higher filaments/filament density.

However, filaments/fibers arranged undirected are conceivable here as well. But in the present embodiment by way of example, they are again stitched on. They again run more or less at right angles to the direction of extent of the contact areas (4, 4′) from one contact area (4) to the other contact area (4′). The mean distance of the filaments/fibers from each other is less in the special area 10 than in the standard area 8, 8′. Hence, the specific conductivity is lower here than that in the standard area 8., 8′.

The mean spacing of the filaments/fibers in the standard area 8, 8′ is about 2 mm. In the special area 10 it is about 4 mm.

Between the standard areas (8, 8′) on the one hand and the special area 10 of the heating resistor 2 on the other hand, a barrier area (16, 16′) is provided in each instance. The barrier area 16 may in the simplest case, as shown here, be a gap. The barrier area (16, 16′) prevents a passage of electric current between the standard areas (8, 8′) and the special area 10.

In operation, the contact areas (4, 4′) are connected to a source (not shown) of electric potential. Current is thereby fed into the one contact area 4. The current then traverses the heating element essentially perpendicular to its lengthwise extent. It thus feeds into the second contact area 4′ on the opposed side of the heating resistor 2 and thence flows back to the voltage source.

The barrier area 16, 16′ might alternatively be created by choosing the distance between the two neighboring marginal filaments/fibers of standard area 8, 8′ and special area 10 sufficiently great. Then a passage of current between the two areas 8, 8′; 10 is likewise ruled out.

Instead of a closer arrangement of the filaments/fibers in the special area 10, the filaments/fibers might alternatively have a larger diameter or be arranged in bundles.

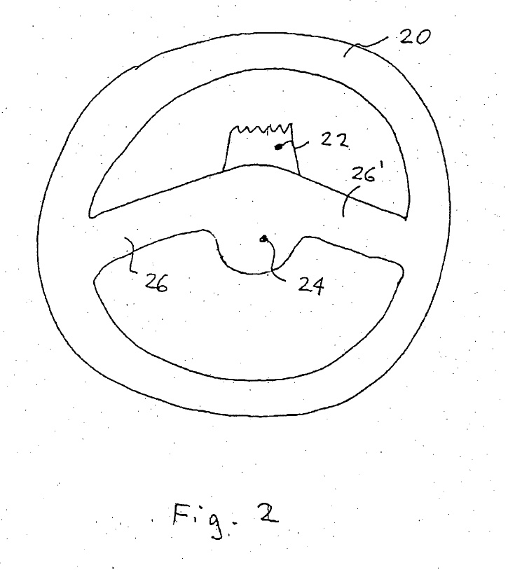

FIG. 2 shows a steering wheel having a circular grip rim 20 connected by spokes 26, 26′ to a center piece 24. The center piece 24 is mounted on a post 22.

It is advantageous to arrange the heating element according to the invention with its lengthwise extent at the circumference of the grip rim. Thus, the standard areas 8, 8′ will be arranged in the normal grip portions of the rim 20. The special area 10 will be arranged at spokes 26, 26′. Also, the heating element 1 will coincide with the junction of the spokes 26, 26′ with the grip rim 20. This ensures that even with thumbs resting on the spokes 26, 26′, the user will not experience any disagreeable sensation of cold.

1. A heating element comprising an areal heating resistor and two electrically conductive elongated contact areas arranged at a distance from each other on the heating resistor with an area of the heating resistor that is to be heated essentially between the contact areas, wherein the heating element resistor defines at least one standard area and at least one special area in which the distances between the contact areas are different, and wherein the heating element comprises at least one barrier area electrically insulating the standard area and the special area from each other, and wherein in the special area, the electrical conductivity of the heating resistor is different from that of the standard area.

2. A heating element according to claim 1, wherein the heating resistor comprises electrically conductive fibers.

3. A heating element according to claim 1, wherein the barrier area is formed by a gap in the heating resistor.

4. A heating element according to claim 2, wherein the fibers are made of carbon or an electrically conductively coated synthetic material.

5. A steering wheel comprising a grip piece, a center piece connectable to a steering post, and at least one spoke connecting the grip piece and the center piece, and a heating element according to claim 1, wherein the heating element is arranged with its special area proximate the spoke and the standard area proximate the grip piece (20).

6. A heating element according to claim 1, wherein the heating resistor comprises electrically conductive filaments.

7. A heating element according to claim 6, wherein the filaments are made of carbon or an electrically conductively coated synthetic material.

8. A heating element according to claim 2, wherein the density of the fibers is different in the special area from the density in the standard area.

9. A heating element according to claim 6, wherein the density of the filaments is different in the special area from the density in the standard area.

10. A heating element according claim 1, wherein the electrical resistance of the special area is approximately equal to the electrical resistance of the standard area.

11. A heating element according claim 1, wherein the distance between the contact areas is greater in the special area than in the standard area.

12. A heating element according to claim 1, wherein the heating resistor comprises electrically conductive undirected fleece stitched to a textile support.

13. A heating element according to claim 1, wherein the heating resistor comprises electrically conductive filaments or fibers running at approximately right angles between the two elongated contact areas.

14. A heating element according to claim 13, wherein the spacing of the filaments or fibers in the special area is approximately 4 mm and in the standard area is approximately 2 mm.

15. A heating element comprising:
two elongated contact areas being electrically conductive;
at least one barrier area being electrically nonconductive; and
a plurality of areal heating resistors spaced between the two elongated contact areas, electrically coupled thereto, and separated by at least one barrier area,
wherein each of the plurality of heating resistors have an electrical conductivity and define a distance between the two elongated contact areas, and wherein at least one of the plurality of areal heating resistors is a special area, and at least one of the plurality of areal heating resistors is a standard area electrically insulated from the special area by at least one barrier area,
wherein the distance between the elongated contact areas is different in the special area than in the standard area.

16. A heating element according to claim 15, wherein each plurality of heating resistors comprises electrically conductive fibers or filaments, and the density of the fibers or filaments is different in the special area from the density in the standard area.

17. A heating element according to claim 16, wherein the fibers or filaments are made of carbon or an electrically conductively coated synthetic material.

18. A heating element according to claim 15, wherein the barrier area is a gap between each of the plurality of areal heating resistors.

19. A heating element according to claim 15, wherein the distance between the elongated contact areas is greater in the special area than in the standard area.

20. A heating element according to claim 15, wherein the plurality of heating resistors comprise an undirected fleece stitched to a textile support.
